(19) United States
(12) Patent Application Publication
(10) Pub. No.: US 2006/0256264 A1
(43) Pub. Date: Nov. 16, 2006

(54) Multi-domain transflective type fringe field switching liquid crystal display

(75) Inventors: Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/130,612

(22) Filed: May 16, 2005

(30) Foreign Application Priority Data
May 14, 2005 (TW) 93113615

(51) Int. Cl. G02F 1/1335; G02F 1/1343

(52) U.S. Cl. 349/114; 349/141

(57) ABSTRACT

A transflective type fringe field switching liquid crystal display (100), includes a first and a second substrates (110, 120) facing each other, a liquid crystal layer (130) contained between the first and second substrates, a plurality of gate lines (121) and a plurality of data lines (122) associated with the first substrate, thereby defining a plurality of pixel regions. Each pixel region includes a transmissive region and a reflective region, a counter electrode (111) and a plurality of pixel electrodes (112) overlying the counter electrode are arranged on each pixel region in order to form one or more fringe electric fields, and each of the pixel electrodes has a bent portion. In each pixel region of the FFS LCD, an electric field in at least two directions is generated between the pixel and counter electrodes so as to form at least two domains. Accordingly, the FFS LCD has a high quality, reliable display.

### FIELD OF THE INVENTION

The present invention relates to liquid crystal displays (LCDs), and more particularly to a multi-domain transflective type fringe field switching (FFS) LCD.

### BACKGROUND

An LCD utilizes the optical and electrical anisotropy of liquid crystal molecules thereof in order to produce an image. The liquid crystal molecules have a particular passive orientation when no voltage is applied thereto. However, when a voltage is applied and the LCD is in a driven state, the liquid crystal molecules change their orientation according to the strength and direction of the driving electric field. A polarization state of incident light changes when the light transmits through the liquid crystal molecules, due to the optical anisotropy of the liquid crystal molecules. The extent of the change depends on the orientation of the liquid crystal molecules. Thus, by properly controlling the driving electric field, an orientation of the liquid crystal molecules is changed and a desired image can be produced.

The twisted nematic (TN) mode LCD was the first main type of LCD developed. Even though TN mode LCDs have been put into use in many applications, they have an inherent drawback that cannot be eliminated; namely, a very narrow viewing angle. By adding compensation films on TN mode LCDs, this problem can be mitigated to some extent. However, the cost of the TN mode LCD is increased. Therefore, an LCD with a totally different driving means has been developed. The LCD is called a fringe field switching (FFS) LCD. The FFS LCD has pixel and counter electrodes usually arranged on two different layers of a same substrate. The distance between the electrodes is narrow, in order to form a fringe electric field about the electrodes.

Usually an LCD needs a planar light source, such as a backlight module, to display images. This kind of LCD is called a transmissive type LCD. In general, the backlight module is the main power consuming component of the transmissive type LCD. In order to reduce power consumption, reflective type LCDs have been developed. A reflective type LCD generally utilizes natural ambient light beams to provide a planar light source. Importantly, the reflective type LCD cannot operate without some kind of external light source. In order to overcome the drawbacks of the two above-described types of LCDs, a transflective type LCD that can operate as both a reflective type LCD and a transmissive type LCD has been developed.

FIG. 8 shows a schematic, side cross-sectional view of part of a conventional FFS LCD. The FFS LCD 1 includes a lower substrate 10, an upper substrate 20 facing the lower substrate 10, and a liquid crystal layer 30 interposed between the substrates 10, 20.

A counter electrode 11, an isolating layer 13, a plurality of parallel pixel electrodes 12, and a lower alignment layer 14 are sequentially arranged on an inner surface of the lower substrate 10. A lower polarizer 15 is arranged on an outer surface of the lower substrate 10.

A color filter 17 and an upper alignment layer 18 are sequentially arranged on an inner surface of the upper substrate 20. An upper polarizer 19 is arranged on an outer surface of the upper substrate 20.

When a voltage is applied to the FFS LCD 1, the FFS LCD 1 is in a driven state. The pixel electrodes 12 and the counter electrode 11 form a fringe electric field to drive liquid crystal molecules 16 of the liquid crystal layer 30, and to thus make the LCD 1 display desired images.

Also referring to FIG. 9, a schematic, cross-sectional top view of pixel electrodes 12 of the FFS LCD 1 is shown. A gate line 21 and a data line 22 are arranged on the lower substrate 10, and cross each other. A thin film transistor (TFT) 23 is disposed in the vicinity of the crossing of the gate line 21 and the data line 22. The pixel electrodes 12 connect to the TFT 23. Each pixel electrode 12 is a linear electrode that is aligned along a single direction.

In summary, the FFS LCD 1 is a conventional single-domain FFS LCD. When a voltage is applied between the pixel and counter electrodes 12 and 11, a single-domain electric field is established between the pixel and counter electrodes 12 and 11. The liquid crystal molecules 16 are twisted so as to align according to the electric field. That is, long axes of the liquid crystal molecules 16 are oriented in a single direction only. This means that an associated display screen exhibits color shift when the display screen is obliquely viewed while displaying white.

What is needed, therefore, is a transflective type FFS LCD which has more than a single domain.

### SUMMARY

In a preferred embodiment of the multi-domain transflective type FFS LCD includes a first and a second substrates facing each other, a liquid crystal layer contained between the first and second substrates, a plurality of gate lines and a plurality of data lines associated with the first substrate, thereby defining a plurality of pixel regions. Each pixel region includes a transmissive region and a reflective region; a counter electrode and a plurality of pixel electrodes overlying the counter electrode are disposed on each pixel region in order to form one or more fringe electric fields, and each of the pixel electrodes has a bent portion.

In a second embodiment of the multi-domain transflective type FFS LCD includes a first and a second substrates facing each other, a liquid crystal layer contained between the first and second substrates, a plurality of gate lines and a plurality of data lines associated with the first substrate, thereby defining a plurality of pixel regions. Each pixel region includes a transmissive region and a reflective region; a counter electrode and a plurality of pixel electrodes overlying with the counter electrode are disposed on each pixel region in order to form at least one fringe electric field, at least one of the pixel electrodes in each pixel region has a bent portion in order to establish an electric field in at least two directions between the pixel electrodes and the counter electrode in the pixel region.

Thus, in each pixel region of the FFS LCD, an electric field in at least two directions is generated between the pixel and counter electrodes so as to form at least two domains. Accordingly, the FFS LCD has a high quality, reliable display.

Other objects, advantages, and novel features will become more apparent from the following detailed description when taken in conjunction with the accompanying drawings, in which:

### BRIEF DESCRIPTION OF THE DRAWINGS

FIG. 1 is a schematic, side cross-sectional view of part of an FFS LCD according to a first embodiment of the present invention;

FIG. 2 is a schematic, cross-sectional top elevation of parts of a pixel region of the FFS LCD of FIG. 1, showing a configuration of pixel electrodes;

FIG. 3 is an enlarged view of a circled portion III of FIG. 2;

FIG. 4 is a schematic, side cross-sectional view of part of an FFS LCD according to a second embodiment of the present invention;

FIG. 5 is a schematic, cross-sectional top elevation of parts of a pixel region of the FFS LCD of FIG. 4, showing a configuration of pixel electrodes;

FIG. 6 is an enlarged view of a circled portion VI of FIG. 5;

FIG. 7 is a schematic, side cross-sectional view of part of an FFS LCD according to a third embodiment of the present invention;

FIG. 8 is a schematic, side cross-sectional view of part of a conventional FFS LCD; and

FIG. 9 is a schematic, cross-sectional top elevation of parts of a pixel region of the FFS LCD of FIG. 8, showing a configuration of a pixel electrode.

### DETAILED DESCRIPTION OF PREFERRED EMBODIMENTS

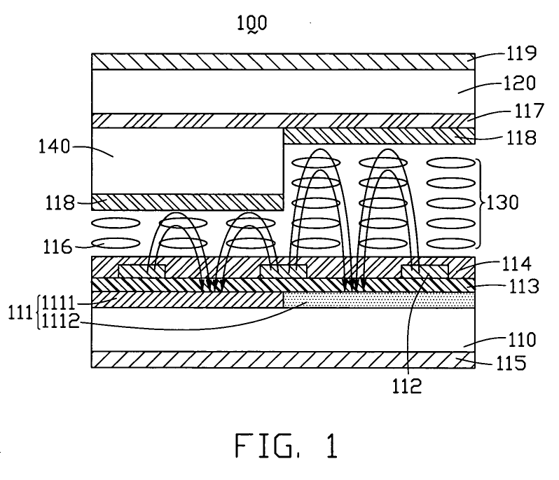

Referring to FIG. 1, an FFS LCD 100 according to a first embodiment of the present invention includes a lower substrate 110, an upper substrate 120 facing the lower substrate 110, and a liquid crystal layer 130 interposed between the lower and upper substrates 110, 120.

A counter electrode 111, an isolating layer 113, a plurality of pixel electrodes 112, and a lower alignment layer 114 are sequentially arranged on an inner surface of the lower substrate 110. A lower polarizer 115 is arranged on an outer surface of the lower substrate 110. The counter electrode 111 includes a transmissive portion 1112 and a reflective portion 1111. The transmissive portion 1112 has a transmissive display function, and the reflective portion 1111 has a reflective display function. Thus a pixel region is divided into a transmissive region and a reflective region.

A color filter layer 117 and an upper alignment layer 118 are sequentially arranged on an inner surface of the upper substrate 120. An upper polarizer 119 is arranged on an outer surface of the upper substrate 120. An overcoat layer 140 is interposed between the color filter layer 117 and the upper alignment layer 118 in the reflective region. Thus, a thickness of the liquid crystal layer 130 in the reflective region is less than a thickness of the liquid crystal layer 130 in the transmissive region.

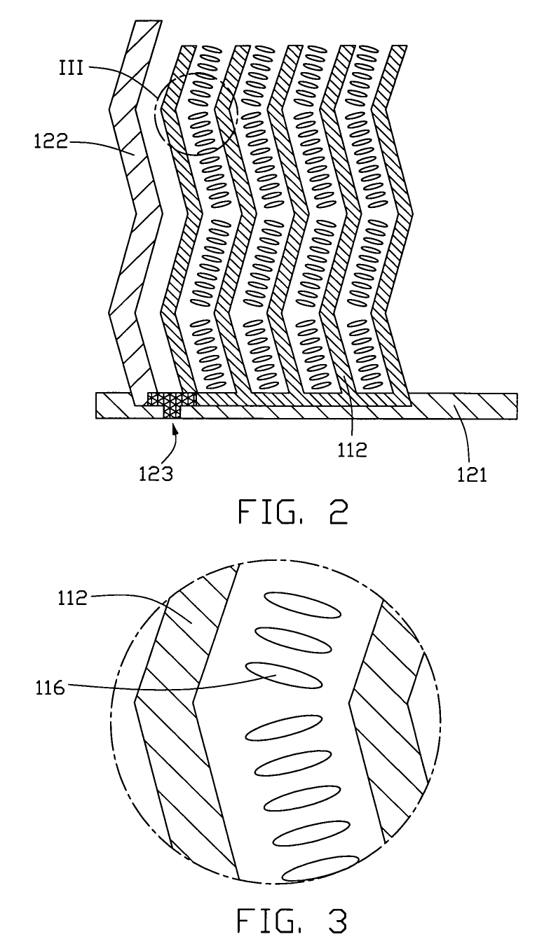

Referring to FIG. 2 and FIG. 3, a gate line 121 and a data line 122 cross each other and define the pixel region. A thin film transistor (TFT) 123 is disposed in the vicinity of the crossing of the gate line 121 and the data line 122. The pixel electrodes 112 connect to the TFT 123. Each pixel electrode 112 has a generally zigzagged configuration, with the pixel electrodes 112 being parallel to each other. The data line 122 may also have a zigzagged configuration, whereby the data line 122 is parallel to the pixel electrodes 112.

When a voltage is applied to the FFS LCD 100, the FFS LCD 100 is in an on state. A fringe electric field distributing in at least two directions is generated between the pixel electrodes 112 and the counter electrode 111 so as to form at least two domains. Liquid crystal molecules 116 are twisted so as to align according to the fringe electric field. That is, long axes of the liquid crystal molecules 116 are oriented in at least two directions. Accordingly, the FFS LCD 100 has a high quality, reliable display.

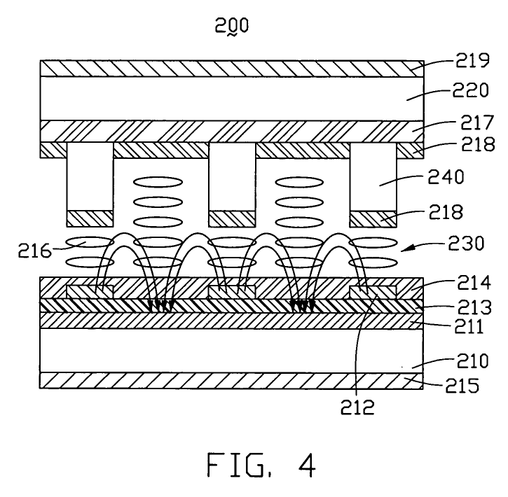

Referring to FIG. 4, an FFS LCD 200 according to a second embodiment of the present invention includes a lower substrate 210, an upper substrate 220 facing the lower substrate 210, and a liquid crystal layer 230 interposed between the lower and upper substrates 210, 220.

A counter electrode 211, an isolating layer 213, a plurality of pixel electrodes 212, and a lower alignment layer 214 are sequentially arranged on an inner surface of the lower substrate 210. A lower polarizer 215 is arranged on an outer surface of the lower substrate 210. The counter electrode 211 is made of a transmissive material, so that it constitutes a transmissive electrode and has a transmissive display function. The pixel electrodes 212 are made of a reflective material, so that they constitute reflective electrodes and have a reflective display function. Thus a pixel region is divided into transmissive regions and reflective regions.

A color filter layer 217 and an upper alignment layer 218 are sequentially arranged on an inner surface of the upper substrate 220. An upper polarizer 219 is arranged on an outer surface of the upper substrate 220. An overcoat layer 240 is interposed between the color filter layer 217 and the upper alignment layer 218 in the reflective regions. Thus, a thickness of the liquid crystal layer 230 in the reflective regions is less than a thickness of the liquid crystal layer 230 in the transmissive regions.

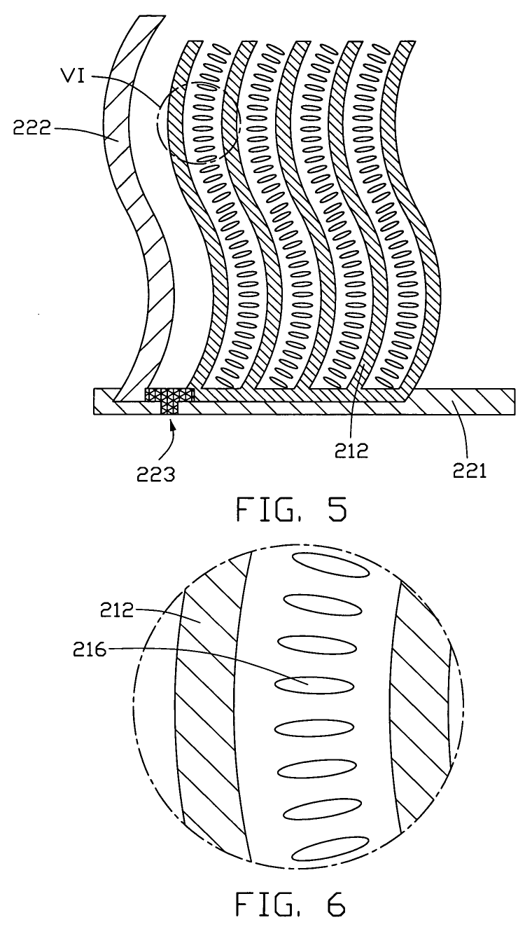

Referring to FIG. 5 and FIG. 6, a gate line 221 and a data line 222 cross each other and define the pixel region. A TFT 223 is disposed in the vicinity of the crossing of the gate line 221 and the data line 222. The pixel electrodes 212 connect to the TFT 223. Each pixel electrode 212 has a wave-shaped configuration, with the pixel electrodes 212 being parallel to each other. The data line 222 may also have a wave-shaped configuration, whereby the data line 222 is parallel to the pixel electrodes 212.

When a voltage is applied to the FFS LCD 200, the FFS LCD 200 is in an on state. A fringe electric field distributing in multi-directions is generated between the pixel electrodes 212 and the counter electrode 211 so as to form multi-domains. Liquid crystal molecules 216 are twisted so as to align according to the fringe electric field. That is, long axes of the liquid crystal molecules 216 are oriented in multi directions. Accordingly, the FFS LCD 200 has a high quality, reliable display.

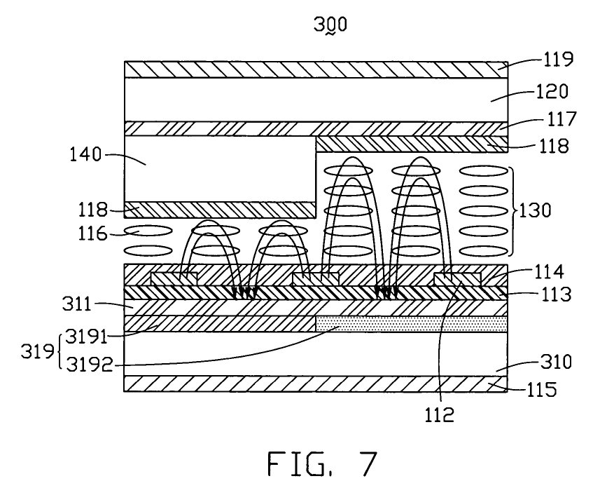

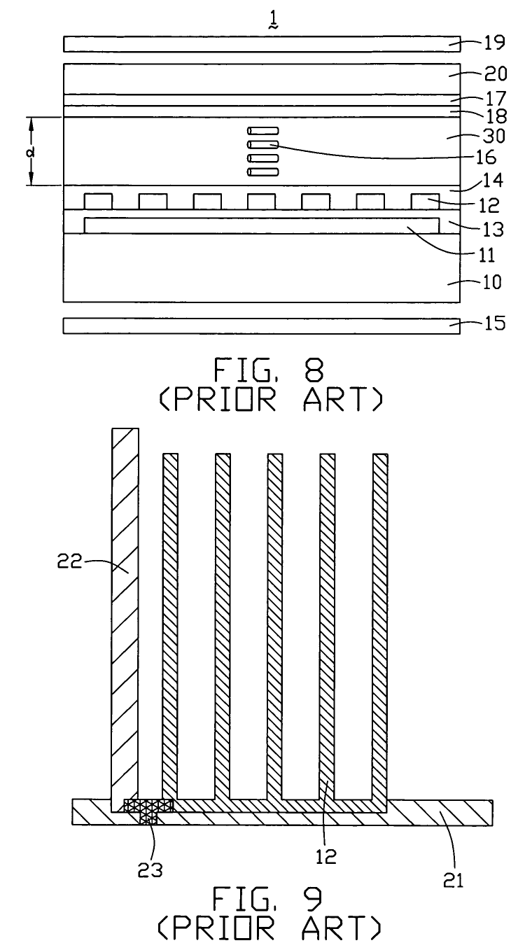

Referring to FIG. 7, an FFS LCD 300 according to a third embodiment of the present invention is similar to the FFS LCD 100 of the first embodiment. However, in the FFS LCD 300, a counter electrode 311 is made of a transmissive material so that it constitutes a transmissive electrode, and a transflector 319 is interposed between a lower substrate 310 and the counter electrode 311. The transflector 319 includes a transmissive portion 3192 and a reflective portion 3191. The transmissive portion 3192 has a transmissive display function, and the reflective portion 3191 has a reflective display function. Thus a pixel region is divided into a transmissive region and a reflective region.

In summary, all the above-described configurations of an FFS LCD provide the following structure, function and advantages. In each pixel region, an electric field in at least two directions is generated between the pixel and counter electrodes so as to form at least two domains. Accordingly, the FFS LCD has a high quality, reliable display.

It is to be understood, however, that even though numerous characteristics and advantages of embodiments of the present invention have been set forth in the foregoing description, together with details of the structure and function of the embodiments, the disclosure is illustrative only, and changes may be made in detail to the full extent indicated by the broad general meaning of the terms in which the appended claims are expressed.

What is claimed is:

1. A transflective type fringe field switching liquid crystal display, comprising:
a first and a second substrates facing each other;
a liquid crystal layer contained between the first and second substrates;
a plurality of gate lines and a plurality of data lines associated with the first substrate, thereby defining a plurality of pixel regions, each pixel region comprising a transmissive region and a reflective region; and
a counter electrode and a plurality of pixel electrodes overlying the counter electrode disposed in the pixel regions in order to form one or more fringe electric fields, each of the pixel electrodes having a bent portion.

2. The transflective type fringe field switching liquid crystal display as claimed in claim 1, wherein the bent portion of each of the pixel electrodes has a generally zigzagged configuration.

3. The transflective type fringe field switching liquid crystal display as claimed in claim 1, wherein the bent portion of each of the pixel electrodes is wave-shaped.

4. The transflective type fringe field switching liquid crystal display as claimed in claim 1, further comprising an isolating layer disposed between the counter and pixel electrodes.

5. The transflective type fringe field switching liquid crystal display as claimed in claim 4, wherein the counter electrode defines a transmissive portion and a reflective portion in each pixel region, the transmissive portion and the reflective portion respectively corresponding to the transmissive region and the reflective region.

6. The transflective type fringe field switching liquid crystal display as claimed in claim 5, further comprising an overcoat layer disposing at an inner surface of the second substrate corresponding to the reflective region in each pixel region.

7. The transflective type fringe field switching liquid crystal display as claimed in claim 4, wherein the pixel electrodes are reflective electrodes and the counter electrode is a transmissive electrode.

8. The transflective type fringe field switching liquid crystal display as claimed in claim 7, further comprising an overcoat layer disposing at an inner surface of the second substrate corresponding to the reflective electrodes in each pixel region.

9. The transflective type fringe field switching liquid crystal display as claimed in claim 4, further comprising a transflector defining transmissive portions and reflective portions disposing between the counter electrode and the first substrate, and wherein the counter electrode constitutes a transmissive electrode.

10. The transflective type fringe field switching liquid crystal display as claimed in claim 9, further comprising an overcoat layer disposing at an inner surface of the second substrate corresponding to the reflective portions of each pixel region.

11. The transflective type fringe field switching liquid crystal display as claimed in claim 1, further comprising a color filter layer and an upper alignment layer disposed at an inner surface of the second substrate.

12. The transflective type fringe field switching liquid crystal display as claimed in claim 11, further comprising an overcoat layer disposing between the color filter layer and the upper alignment layer in locations corresponding to the reflective regions.

13. The transflective type fringe field switching liquid crystal display as claimed in claim 12, wherein a thickness of the liquid crystal layer corresponding to the reflective regions is less than a thickness of the liquid crystal layer corresponding to the transmissive regions.

14. A transflective type fringe field switching liquid crystal display, comprising:
a first and a second substrates facing each other;
a liquid crystal layer contained between the first and second substrates;
a plurality of gate lines and a plurality of data lines associated with the first substrate, thereby defining a plurality of pixel regions, each pixel region comprising a transmissive region and a reflective region; and
a counter electrode and a plurality of pixel electrodes overlying the counter electrode disposing in the pixel regions in order to form at least one fringe electric field, at least one of the pixel electrodes in each pixel region having a bent portion in order to establish an electric field in at least two directions between the pixel electrodes and the counter electrode in the pixel region.

15. The transflective type fringe field switching liquid crystal display as claimed in claim 14, wherein liquid crystal molecules in the liquid crystal layer can be simultaneously twisted in at least two different directions in each pixel region.

16. The transflective type fringe field switching liquid crystal display as claimed in claim 14, wherein the bent portion of each of the pixel electrodes has a generally zigzagged configuration.

17. The transflective type fringe field switching liquid crystal display as claimed in claim 14, wherein the bent portion of each of the pixel electrodes is wave-shaped.

18. The transflective type fringe field switching liquid crystal display as claimed in claim 14, wherein the counter electrode defines a transmissive portion and a reflective portion in each pixel region, the transmissive portion and the reflective portion respectively corresponding to the transmissive region and the reflective region.

19. The transflective type fringe field switching liquid crystal display as claimed in claim 14, wherein the pixel electrodes are reflective electrodes and the counter electrode is a transmissive electrode.

20. The transflective type fringe field switching liquid crystal display as claimed in claim 14, further comprising a transflector defining a transmissive portion and a reflective portion disposed between the counter electrode and the first substrate, and wherein the counter electrode constitutes a transmissive electrode.

21. The transflective type fringe field switching liquid crystal display as claimed in claim 14, further comprising a color filter layer, an overcoat layer and an upper alignment layer disposed at an inner surface of the second substrate, and the overcoat layer is disposed between the color filter layer and the upper alignment layer in locations corresponding to the reflective regions.

22. The transflective type fringe field switching liquid crystal display as claimed in claim 21, wherein a thickness of the liquid crystal layer corresponding to the reflective regions is less than a thickness of the liquid crystal layer corresponding to the transmissive regions.
